(19) United States
(12) Patent Application Publication
(10) Pub. No.: US 2015/0056405 A1
(43) Pub. Date: Feb. 26, 2015

(54) MARBLE CHIP FLOORING MATERIAL USING PLA RESIN

(71) Applicant: LG Hausys, Ltd., Seoul (KR)

(72) Inventor: Chul Hyun Kim, Cheongju-si (KR)

(21) Appl. No.: 14/389,678

(22) PCT Filed: Dec. 27, 2012
(86) PCT No.: PCT/KR2012/011525

§ 371 Date: Sep. 30, 2014

(30) Foreign Application Priority Data
Apr. 16, 2012 (KR) 10-2012-0038984

(51) Int. Cl. B32B 7/12; B32B 27/36; B32B 37/02; B32B 37/10; E04F 15/00; B32B 37/14; B29D 99/00; E04B 5/00; E04C 2/26; E04B 2/00; B32B 21/12; B32B 37/12

(52) U.S. Cl. CPC B32B 7/12; B32B 21/12; B32B 27/36; B32B 37/02; B32B 37/10; B32B 37/1284; B32B 37/144; B29D 99/0057; E04B 5/00; E04C 2/26; E04C 2/44; E04F 15/00; B32B 2260/046; B29K 2067/046
USPC 428/106; 156/60; 156/242

(57) ABSTRACT

The present invention provides a PLA flooring material comprising: a marble chip surface layer comprising a PLA (poly lactic acid) resin; an adhesive layer and a plywood layer formed under the marble chip surface layer; and a surface treatment layer formed on the marble chip surface layer. In addition, the present invention provides a method for manufacturing a marble chip flooring material, comprising the steps of: preparing a marble chip surface layer comprising a PLA resin; forming an adhesive layer and a plywood layer under the marble chip surface layer; and forming a surface treatment layer on the marble chip surface layer.

### TECHNICAL FIELD

The present invention relates to a marble chip flooring material, and more particularly, to a marble chip flooring material including a marble chip surface layer, an adhesive layer, a plywood layer and a surface treatment layer.

### BACKGROUND ART

Flooring materials based on petroleum resins such as polyvinyl chloride (PVC) and the like are mainly used in building structures such as houses, mansions, apartments, offices, shops, and the like. Flooring materials using polyvinyl chloride (PVC) and the like are prepared through extrusion or calendering of a resin such as polyvinyl chloride (PVC) and the like. However, since raw materials for the polyvinyl chloride resin are based on petroleum resources, there can be various problems related to the supply of raw materials in the future due to depletion of petroleum resources. Moreover, since polyvinyl chloride (PVC) flooring materials generate various toxic substances when used or discarded, use thereof needs to be avoided in terms of environmental friendliness. Thus, instead of the polyvinyl chloride flooring materials, interest in eco-friendly resin-based green flooring materials is increasing in recent years.

In the related art, Korean Patent Publication No. 10-2011-0052528 and No. 10-2011-0032536 disclose a composition for flooring materials and an eco-friendly flooring material, which use polylactic acid capable of being prepared from a raw material extracted from renewable plant resources and exhibit excellent physical properties, wherein the flooring material includes a print layer, a surface protective layer and the like.

However, these publications do not disclose a functional layer which can provide natural appearance together with surface protection, and the present invention is aimed at providing a flooring material including a marble chip surface layer capable of serving various functions.

### DISCLOSURE

### Technical Problem

It is an aspect of the present invention to provide an eco-friendly marble chip flooring material which has an amorphous marble pattern realizing natural appearance using a marble chip surface layer including a PLA resin. In addition, it is another aspect of the present invention to provide a method for preparing a marble chip flooring material.

### Technical Solution

In accordance with one aspect of the present invention, a marble chip flooring material includes: a marble chip surface layer including a polylactic acid (PLA) resin; an adhesive layer and a plywood layer formed on a lower side of the marble chip surface layer; and a surface treatment layer formed on an upper side of the marble chip surface layer.

In accordance with another aspect of the present invention, a method for preparing a marble chip flooring material includes: preparing a marble chip surface layer including a PLA resin; forming an adhesive layer and a plywood layer on a lower side of the marble chip surface layer; and forming a surface treatment layer on an upper side of the marble chip surface layer.

### Advantageous Effects

According to the present invention, the marble chip flooring material is an eco-friendly flooring material which can be reliably used by application of natural materials, and provides outstanding effects in terms of use and maintenance thereof since the marble chip flooring material is free from discoloration due to water and exhibits excellent surface strength.

In addition, the method for preparing a marble chip flooring material enables preparation of a marble chip flooring material including an amorphous marble pattern having a wavy and rough surface appearance.

### DESCRIPTION OF DRAWINGS

FIG. 1 shows a typical PLA flooring material having a PLA surface layer including a PLA resin.

FIG. 2 shows a marble chip flooring material having a marble chip surface layer including a PLA resin according to one embodiment of the present invention.

FIG. 3 is pictures showing weather resistance (ΔE) changes over time as observed in flooring materials of Example and Comparative Example 1.

FIG. 4 is pictures showing color changes over time due to floor moisture as observed in flooring materials of Example and Comparative Example 1.

FIG. 5 is pictures showing color changes over time due to surface-permeating moisture as observed in flooring materials of Example and Comparative Example 1.

FIG. 6 is pictures showing dents in flooring materials due to dent damage as observed in flooring materials of Example and Comparative Example 1.

FIG. 7 is pictures showing dents and scratches in flooring materials due to scratches depending upon test items as observed in flooring materials of Example and Comparative Example 1.

FIG. 8 is pictures showing results of an indentation test using a caster resistance tester as observed in flooring materials of Example and Comparative Example 1.

FIG. 9 is pictures showing results of a dent test using an impact resistance tester as observed in flooring materials of Example and Comparative Example 1.

### BEST MODE

The above and other aspects, features and advantages of the present invention will become apparent from the detailed description of the following embodiments in conjunction with the accompanying drawings. However, it should be understood that the present invention is not limited to the following embodiments and may be embodied in different ways, and that the embodiments are provided for complete disclosure and thorough understanding of the invention by those skilled in the art. The scope of the invention should be defined only by the accompanying claims and equivalents thereof. Like components will be denoted by like reference numerals throughout the specification.

Hereinafter, embodiments of the present invention will be described in detail with reference to the accompanying drawings.

Marble Chip Flooring Material

According to the present invention, a marble chip flooring material includes: a marble chip surface layer including a polylactic acid (hereinafter referred to as “PLA”) resin; an adhesive layer and a plywood layer formed on a lower side of the marble chip surface layer; and a surface treatment layer formed on an upper side of the marble chip surface layer.

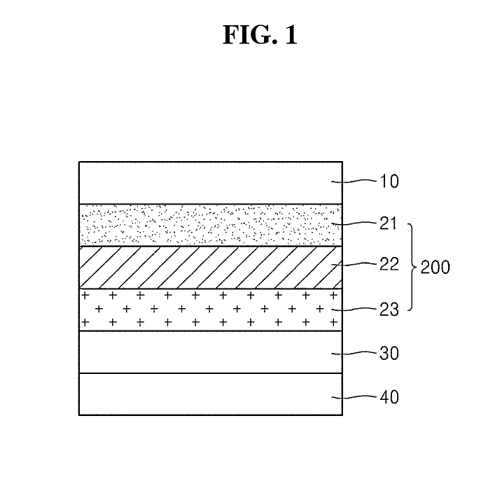

Referring to FIG. 1, typically, a transparent layer 21, a print layer 22, and a foamed or non-foamed layer 23 are individually prepared through calendaring. Here, the transparent layer 21 protects a print pattern of the print layer and a flooring material from external impact; the print layer 22 has the print pattern and realizes external appearance; and the foamed or non-foamed layer 23 allows the flooring material to maintain strength. In addition, the flooring material may further include a dimensionally stabilizing layer to prevent phenomena, such as dimensional change, and gap generation between pieces of the flooring material, due to temperature change caused by heating and the like.

However, unlike typical PLA films, without need of individually stacking the transparent layer 21, the print layer 22 and the foamed or non-foamed layer 23, the plural layers are integrated into one layer and thus prepared into a marble chip surface layer 20 according to the present invention, which provides natural appearance together with surface protection. Thus, there is an advantage in that the marble chip surface layer 20 according to the present invention can provide various functions, such as excellent surface strength and durability, prevention of shrinkage and gap generation due to temperature change and the like.

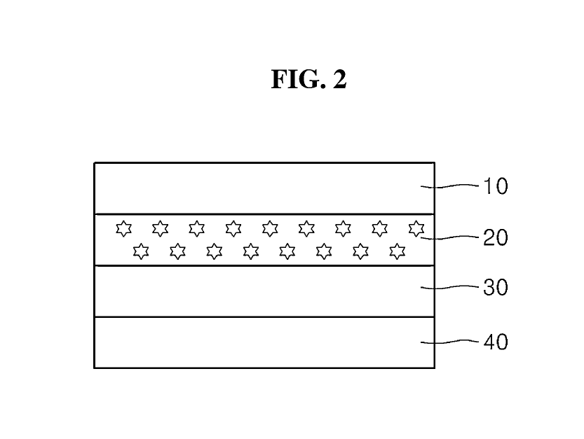

Referring to FIG. 2, the marble chip flooring material according to the present invention includes, from top to bottom, a surface treatment layer 10, a marble chip surface layer 20, an adhesive layer 30 and a plywood layer 40, wherein the marble chip surface layer 20 includes a PLA resin. In addition, the marble chip flooring material may also have a structure in which the surface treatment layer 10 is omitted.

According to the present invention, the marble chip surface layer 20 includes the PLA resin. Here, the polylactic acid (PLA) resin is a thermoplastic polyester of lactide or lactic acid, and may be prepared by polymerization of lactic acid which is prepared by fermentation of starch extracted from renewable plant resources such as corn, potatoes and the like. The PLA resin emits a much smaller amount of environmentally toxic substances, such as CO₂ and the like, during use or disposal than petroleum-based materials, such as polyvinyl chloride (PVC) and the like, and is eco-friendly in that the PLA resin is easily degradable in a natural environment even when discarded. Typically, the PLA resin can be classified into D-PLA, L-PLA, D,L-PLA or meso-PLA, and the like. The PLA resin according to the present invention may be any PLA resin without limitation, and may be prepared using various PLA resins alone or in combination thereof.

As described above, the PLA resin may be prepared by polymerization of lactic acid or lactide, and may also be prepared by copolymerization of lactic acid or lactide with an appropriate copolymerization component, such as: glycol compounds including ethylene glycol, propylene glycol and the like; dicarboxylic acids including ethanedioic acid, terephthalic acid and the like; hydroxycarboxylic acids including glycolic acid, 2-hydroxybenzoic acid and the like; and lactones including caprolactone, propiolactone and the like, as needed. In addition, the PLA resin according to the present invention may be used in a blended form in which a PLA resin is blended with other resins such as synthetic resins and the like.

More specifically, the marble chip surface layer 20 may include at least one of 5 parts by weight to 60 parts by weight of a non-phthalate plasticizer, 5 parts by weight to 60 parts by weight of an epoxy, 0.01 parts by weight to 10 parts by weight of stearic acid as a lubricant, 5 parts by weight to 30 parts by weight of a higher fatty acid, 10 parts by weight or less of an anti-hydrolysis agent, 500 parts by weight to 700 parts by weight of calcium carbonate, 5 parts by weight or less of titanium dioxide, 20 parts by weight or less of pine resin, and 5 parts by weight to 10 parts by weight of a pigment, based on 100 parts by weight of the PLA resin.

First, the non-phthalate plasticizer increases thermoplasticity of the PLA resin by softening the PLA resin and thus facilitates molding at high temperature. According to the present invention, the non-phthalate plasticizer may be acetyl tributyl citrate (ATBC).

Here, the non-phthalate plasticizer may be present in an amount of 5 parts by weight to 60 parts by weight based on 100 parts by weight of the PLA resin. If the amount of the non-phthalate plasticizer is less than 5 parts by weight, the flooring material can suffer from deterioration in processability due to increased hardness of the PLA resin, and if the amount of the non-phthalate plasticizer is greater than 60 parts by weight, the flooring material can suffer from deterioration in properties such as processability and the like due to deterioration in compatibility of the non-phthalate plasticizer with other components forming the individual layers.

Next, the marble chip surface layer may include the lubricant to prevent accumulation of deposits or crosslinked products during melt extrusion and the like. When a resin composition according to the present invention is molded, the lubricant can improve fluidity and slipping capability of the composition and prevent adhesion of the resin to a metallic apparatus by lubricating a surface of the metallic apparatus such as calendar rollers and the like, and can maximize moldability, particularly, calendering moldability by adjusting melt viscosity of the composition.

Embodiments of the present invention employ a higher fatty acid as an eco-friendly lubricant among various lubricants. Specifically, as the lubricant, stearic acid corresponding to a C₁₈ saturated higher fatty acid may be present in an amount of 0.01 parts by weight to 10 parts by weight, or a C₁₈ or higher fatty acid may be present in an amount of 5 parts by weight to 20 parts by weight. The lubricants may be used alone or in combination thereof.

If the amount of the lubricant is less than the lower limit of the above range based on 100 parts by weight of the PLA resin, the lubricant cannot function effectively, and if the amount of the lubricant is greater than the upper limit of the above range, the PLA resin can suffer from deterioration in impact resistance, heat resistance, gloss and the like.

According to the present invention, the marble chip surface layer may include 5 parts by weight to 60 parts by weight of the epoxy based on 100 parts by weight of the PLA resin. If the amount of the epoxy is less than 5 parts by weight, the epoxy cannot function effectively and cannot allow reduction in amount of the plasticizer used, and if the amount of the epoxy is greater than 60 parts by weight, there is a problem of deterioration in adhesion of the marble chip surface layer to a surface protection layer.

According to the present invention, the marble chip surface layer may include calcium carbonate. Calcium carbonate is generally a colorless crystal or a white solid, has a specific gravity of 2.93, is degraded at 825° C., and can produce quicklime while generating carbon dioxide when heated. Since calcium carbonate is more readily available and lower-priced than petrochemicals, it is advantageous that a content ratio of calcium carbonate is as high as possible so long as basic properties of the flooring material are not damaged.

In particular, calcium carbonate may be present in an amount of 500 parts by weight to 700 parts by weight based on 100 parts by weight of the PLA resin. If the amount of calcium carbonate is less than 500 parts by weight, there is a concern of deformation of the flooring material due to heat and the flooring material can suffer from dents due to heavy weight, and if the amount of calcium carbonate is greater than 700 parts by weight, there is a problem in that kneading of calcium carbonate with the PLA resin is not properly performed.

In addition, the marble chip surface layer may include the anti-hydrolysis agent to prevent deterioration in mechanical properties, such as impact resistance and the like, due to hydrolysis of the PLA resin. The anti-hydrolysis agent may be carbodiimide or oxazoline.

The anti-hydrolysis agent may be present in an amount of 10 parts by weight or less based on 100 parts by weight of the PLA resin. If the amount of the anti-hydrolysis agent is greater than 10 parts by weight, the resin composition can suffer from deterioration in moldability.

Further, the marble chip surface layer may include 5 parts by weight to 10 parts by weight of the pigment based on 100 parts by weight of the PLA resin. The pigment may include organic and inorganic pigments. More specifically, the inorganic pigment may include rutile type titanium dioxide, zinc oxide, iron oxide, chromium oxide and the like, and may also include alumina, zinc sulfide and the like. The organic pigment may include natural pigments and synthetic pigments, and has merits such as a wide range of color, clear color and excellent coloring strength. In addition, the marble chip surface layer may further include other pigments in addition to the organic or inorganic pigment so long as the other pigments do not affect processability in preparation of the marble chip flooring material.

If the amount of the pigment is less than 5 parts by weight based on 100 parts by weight of the PLA resin, it is difficult to obtain a desired marble color, and if the amount of the pigment is greater than 10 parts by weight, there is a problem in that a marble color darkens. In addition, if the marble chip surface layer 20 includes greater than 5 parts by weight of titanium dioxide or greater than 20 parts by weight of pine resin, there is no additional enhancement of effects by increasing the amount thereof.

The marble chip surface layer 20 has a thickness from 0.2 mm to 5.0 mm. If the thickness of the marble chip surface layer is less than 0.2 mm, there is a problem of thickness deviation upon preparation of the marble chip surface layer, and if the thickness of the marble chip surface layer is greater than 5.0 mm, there can be a problem in transport of the marble chip surface layer due to increased weight thereof.

The marble chip surface layer 20 has an amorphous marble pattern having a wavy and rough-surface appearance. Thus, the marble chip surface layer is formed to have an appearance of a unique and wavy marble pattern in conjunction with some directionality by modifying not only typical marble tiles prepared to have directionality but also non-directional tiles free from directionality.

The marble chip surface layer 20 may include the surface treatment layer 10 formed on an upper side thereof. The surface treatment layer 10 may be applied to an upper surface of a board composite having a PLA cover as shown in FIG. 2 to improve surface quality such as scratch resistance, abrasion resistance and the like, or to facilitate cleaning through improvement of contamination resistance. Here, the surface treatment layer 10 may be formed of a material including polyurethane, polyurethane acrylate, or wax.

In addition, the marble chip surface layer 20 may include the adhesive layer 30 and the plywood layer 40 formed on a lower side thereof.

The adhesive layer 30 may include at least one selected from among epoxy, urethane, vinyl acetate, and acrylic resins. Since the adhesive layer serves to bond the marble chip surface layer 20 according to the present invention to the plywood layer 40 after being formed on the plywood layer 40 using a roll and a spreader coater, a process of bonding the marble chip surface layer 20 to the plywood layer 40 via the adhesive layer 30 can also be facilitated.

Here, the adhesive layer 30 may have a thickness from 0.01 mm to 0.5 mm. If the thickness of the adhesive layer 30 is less than 0.01 mm, there is a concern of detachment between the marble chip surface layer 20 and the plywood layer 40, and if the thickness of the adhesive layer 30 is greater than 0.5 mm, there are problems such as leakage of adhesives upon pressing for bonding, and long curing time.

The plywood layer 40 may be selected from among medium density fiberboard (MDF), plywood, cellulose fiber reinforced cement boards, magnesium boards, reclaimed wood, high density fiberboard (HDF), particle board (PB), ceramic tiles, porcelain tiles, ceramic boards and click fasteners, and thus form various forms of building materials.

Further, the plywood layer 40 according to the present invention may be subjected to tongue and groove (T/G) processing. The plywood layer 40 is not limited to a board form or the above materials, and may be utilized in various fields such as interior/exterior materials and flooring materials for construction which can be used in a board form, and the like.

Method for Preparing Marble Chip Flooring Material

According to the present invention, a method for preparing a marble chip flooring material includes: preparing a marble chip surface layer including a PLA resin; forming an adhesive layer and a plywood layer on a lower side of the marble chip surface layer; and forming a surface treatment layer on an upper side of the marble chip surface layer.

Here, preparing the marble chip surface layer may include: kneading a composition, which includes at least one of 5 parts by weight to 60 parts by weight of a non-phthalate plasticizer, 5 parts by weight to 60 parts by weight of an epoxy, 0.01 parts by weight to 10 parts by weight of stearic acid as a lubricant, 5 parts by weight to 30 parts by weight of a higher fatty acid, 10 parts by weight or less of an anti-hydrolysis agent, 500 parts by weight to 700 parts by weight of calcium carbonate, 5 parts by weight or less of titanium dioxide, 20 parts by weight or less of pine resin, and 5 parts by weight to 10 parts by weight of a pigment, based on 100 parts by weight of the PLA resin; and forming a marble chip surface layer by mixing the kneaded composition.

Kneading the composition may include mixing raw materials of the composition, adding various additives to the mixed raw materials, and pressurization and heating. The composition kneaded through the above processes is uniformly mixed, followed by preparing the marble chip surface layer in sheet form. Here, since the marble chip surface layer 20 may be prepared in sheet form, the method may include forming an amorphous marble pattern having a wavy and rough surface appearance by rolling in a calendar.

Although the present invention has been described with reference to some embodiments, it should be understood that the foregoing embodiments are provided for illustrative purposes only, and that various modifications, changes, alterations, and equivalent embodiments can be made by those skilled in the art without departing from the spirit and scope of the invention. Therefore, the scope of the invention should be limited only by the accompanying claims.

### EXAMPLES

### Preparation of Marble Chip Surface Layer

A 1.5 mm thick marble chip surface layer was prepared using 100 parts by weight of a PLA resin (2002D (Nature Works Co., Ltd.):4060D (Nature Works Co., Ltd.)=9:1), 550 parts by weight of calcium carbonate, 15 parts by weight of a non-phthalate plasticizer (ATBC), 30 parts by weight of an epoxy, 0.8 parts by weight of stearic acid, 15 parts by weight of a higher fatty acid, 2.0 parts by weight of carbodiimide, 2 parts by weight of titanium dioxide, 10 parts by weight of pine resin, and 6 parts by weight of a pigment.

Preparation of Surface Treatment Layer, Adhesive Layer and Plywood Layer

An about 0.1 mm thick surface treatment layer was formed on an upper surface of the prepared marble chip surface layer using a polyurethane acrylate UV paint, and an acrylic resin-containing adhesive layer was formed on a lower surface of the prepared marble chip surface layer using a roll and a spreader coater. Here, the adhesive layer had a thickness of 0.15 mm and served to bond a 5-ply plywood layer to the prepared marble chip surface layer.

As a result, a marble chip flooring material including the marble chip surface layer, the surface treatment layer, the adhesive layer and the plywood layer was prepared.

### Comparative Example 1

A marble chip flooring material was prepared in the same manner as in Example except that the marble chip surface layer was formed using 100 parts by weight of a PLA resin (2002D, Nature Works Co., Ltd.), 15 parts by weight of a non-phthalate plasticizer (ATBC), 10 parts by weight of an acrylic copolymer, 5 parts by weight of stearic acid, 5 parts by weight of diisocyanate, 5 parts by weight of carbodiimide, 300 parts by weight of calcium carbonate, and 2 parts by weight of titanium dioxide.

### Comparative Example 2

A marble chip flooring material was prepared in the same manner as in Example except that the marble chip surface layer was formed using 100 parts by weight of a PLA resin (2002D (Nature Works Co., Ltd.):4060D (Nature Works Co., Ltd.)=9:1), 300 parts by weight of calcium carbonate, 3 parts by weight of a non-phthalate plasticizer (ATBC), 2 parts by weight of an epoxy, 0.005 parts by weight of stearic acid, 2 parts by weight of a higher fatty acid, 30 parts by weight of carbodiimide, 20 parts by weight of titanium dioxide, 30 parts by weight of pine resin, and 2 parts by weight of a pigment.

### Comparative Example 3

A marble chip flooring material was prepared in the same manner as in Example except that the marble chip surface layer was formed using 100 parts by weight of a PLA resin (2002D (Nature Works Co., Ltd.):4060D (Nature Works Co., Ltd.)=9:1), 900 parts by weight of calcium carbonate, 100 parts by weight of a non-phthalate plasticizer (ATBC), 90 parts by weight of an epoxy, 20 parts by weight of stearic acid, 50 parts by weight of a higher fatty acid, 50 parts by weight of carbodiimide, 50 parts by weight of titanium dioxide, 60 parts by weight of pine resin, and 20 parts by weight of a pigment.

### Experimental Example 1

### Content of Volatile Organic Compound in Relation to Environmental Friendliness

To confirm environmental friendliness of the flooring materials prepared in Example and Comparative Examples, a test to determine emission of volatile organic compounds (T-VOCs) and formaldehyde (HCHO) was requested to the Korea Institute of Construction Materials, and the test was performed in accordance with the Indoor Air Quality Standard Method. Results are shown in Table 1.

TABLE 1

| | | | Comparative | Comparative | Comparative |
|---|---|---|---|---|---|
| Quality item | Certified standard | Example | Example 1 | Example 2 | Example 3 |
| T-VOCs (mg/m² · h) | <0.100 | 0.041 | 0.053 | 0.071 | 0.064 |
| HCHO (mg/m² · h) | <0.015 | 0.002 | 0.002 | 0.005 | 0.003 |

From the results, since it could be seen that the flooring material of Example emitted a lower amount of volatile organic compounds (T-VOCs) and formaldehyde (HCHO) than those of Comparative Examples, it was confirmed that the flooring material including the marble chip surface layer of Example was eco-friendly. In addition, since the amount of emission of volatile organic compounds (T-VOCs) and formaldehyde (HCHO) of the flooring material of Example met the certified standard, it could be envisaged that the flooring material of Example would serve as an outstanding flooring material.

### Experimental Example 2

### Discoloration of Flooring Material

To evaluate weather resistance of each of the flooring materials of Example and Comparative Examples, a test for discoloration due to sunlight was performed using a QUV-promoted weather resistance tester. Here, each of the flooring materials was irradiated with a mercury lamp at 400 W and 3,000 A for 48 hours, thereby measuring a weather resistance (ΔE). Results are shown in Table 2.

In addition, discoloration due to floor moisture from cracks of the flooring material upon heating was evaluated. Here, for 3 days, a constant-temperature water bath at 60° C. was repeatedly turned on for 8 hours and turned off for 16 hours, thereby observing the flooring material. Further, in order to evaluate discoloration due to surface-permeating moisture, a surface of each of the flooring materials prepared in Examples and Comparative Examples was dipped in water, thereby observing the flooring material every day for five days.

TABLE 2

| | | | Comparative | | Comparative | | Comparative | |
|---|---|---|---|---|---|---|---|---|
| Quality item | Example | | Example 1 | | Example 2 | | Example 3 | |
| Weather | After 1 day | 0.87 | After 1 day | 2.60 | After 1 day | 2.89 | After 1 day | 2.1 |
| resistance | After 2 days | 1.21 | After 2 days | 3.73 | After 2 days | 3.21 | After 2 days | 2.65 |
| (ΔE) | After 3 days | 1.77 | After 3 days | 3.29 | After 3 days | 3.56 | After 3 days | 3.57 |

| | | | | |
|---|---|---|---|---|
| Discoloration | Good | Surface blackening | Surface blackening | Surface blackening |
| due to floor | | | | |
| moisture | | | | |
| Discoloration | Good | Surface blackening | Surface blackening | Surface blackening |
| due to surface- | | | | |
| permeating | | | | |
| moisture | | | | |

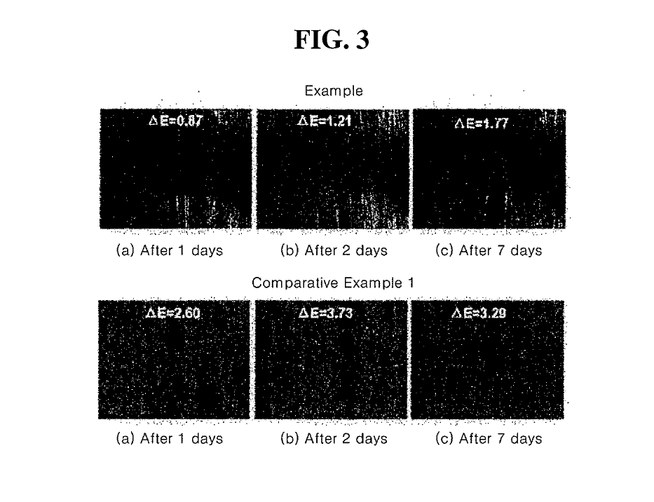

If the flooring material has a degree of weather resistance (ΔE) of 2 or more, discoloration of the flooring material is visible when observed with the naked eye. All of the flooring materials of Comparative Examples had a discoloration degree (ΔE) of 2 or more. However, it could be seen that the flooring material of Example exhibited lower discoloration over time than Comparative Examples, and the reason was that the flooring material of Example was resistant to discoloration due to sunlight since the marble chip surface layer of Example was free from lignin, which is the primary cause of discoloration. FIG. 3 is pictures showing weather resistance (ΔE) changes over time as observed with respect to the flooring materials of Example and Comparative Example 1, and it could be confirmed that the flooring material of Example was less discolored than that of Comparative Example 1.

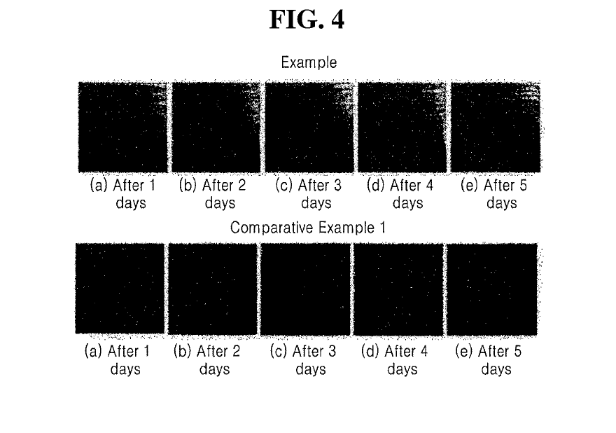

FIG. 4 is pictures showing color changes over time due to floor moisture as observed with respect to the flooring materials of Example and Comparative Example 1, and it could be confirmed with the naked eye that the flooring material of Comparative Example 1 suffered from surface blackening. Conversely, it could be confirmed that the flooring material of Example did not show any change due to moisture and was maintained in a good state.

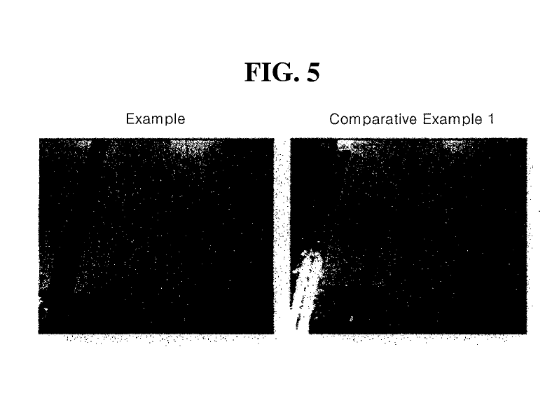

FIG. 5 is pictures showing color changes over time due to surface-permeating moisture as observed with respect to the flooring materials of Example and Comparative Example 1, and it could be confirmed with the naked eye that the flooring material of Comparative Example 1 suffered from surface blackening since the flooring material of Comparative Example 1 suffered from more severe discoloration due to floor moisture with the lapse of time from the first day to the fifth day. However, since it could be confirmed that the flooring material of Example did not suffer from discoloration and exhibited a good state regardless of the lapse of time, it could be seen that the flooring material of Example exhibited excellent moisture resistance.

### Experimental Example 3

### Physical Properties of Flooring Material

To measure a dent in each of the flooring materials of Example and Comparative Examples, a test was performed using a self-made driver dropping tester while a dropping interval was increased by 50 mm each time, followed by observing the flooring material with the naked eye. Here, minimum dropping distance at which a dent was generated is shown in Table 3.

In addition, dents/scratches due to scratch damage were measured using a self-made surface strength tester, and minimum force at which a scratch was generated is shown in Table 3. More specifically, test items included tests for plastic ruler-induced dents, coin-induced dents, coin-induced scratches, and metal key-induced scratches. Here, a rotational speed in the test for coin-induced dents was 1,000 mm/sec, and a moving load and a speed in the tests for coin-induced scratches and metal key-induced scratches were 11 kg and 500 mm/sec, respectively.

Further, a chair loaded to 55 kg and having casters was subjected to reciprocating motion 500 times or more, thereby evaluating caster resistance, and to evaluate impact resistance, a 286 g weight was dropped onto a surface of each of the flooring materials of Example and Comparative Examples at intervals of a height of 50 mm using an impact resistance tester. Results are shown in Table 3.

TABLE 3

| | | Comparative | Comparative | Comparative |
|---|---|---|---|---|
| Quality item | Example | Example 1 | Example 2 | Example 3 |
| Dent resistance | 300 or more | 100 or less | 50 or less | 150 or less |
| (mm) | | | | |
| Scratch (N) | 3.0 | 2.0 | 2.0 | 1.5 |
| Caster | 2,000 times | 1,000 times | 800 times | 700 times |
| resistance | or more | or less | or less | or less |
| (casters of | | | | |
| chair) | | | | |
| Impact | 50 or more | 10 or more | 30 or more | 10 or more |
| resistance | | | | |
| (cm) | | | | |

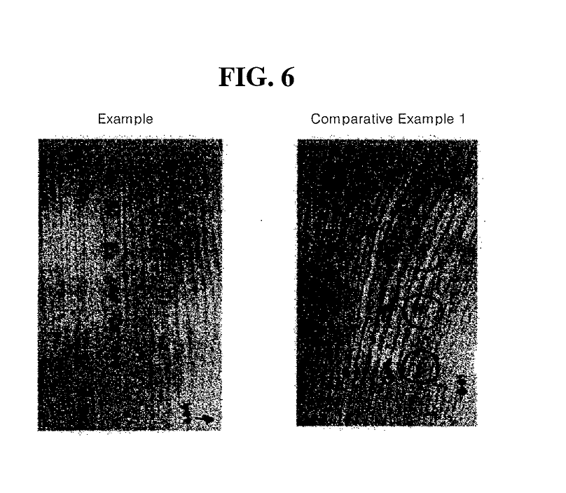

FIG. 6 is pictures showing dents of the flooring materials due to dent damage as observed with respect to the flooring materials of Example and Comparative Example 1. It could be seen that the flooring material of Example did not suffer from any dents even when a driver was dropped from a height of 300 mm or more. However, it could be confirmed that the flooring material of Comparative Example 1 started to suffer from dents when the driver was dropped from a height of 50 mm, and that a dent was clearly visible even with the naked eye when the driver was dropped from a height of 100 mm or more.

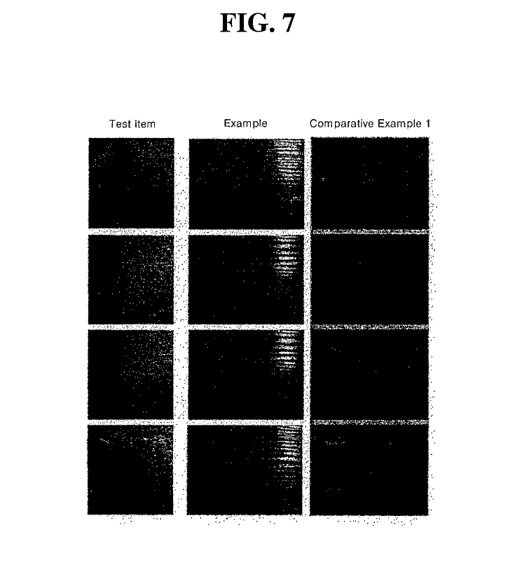

In the scratch test, since the flooring material of Example had a scratch-inducing force of 3.0 N and the flooring materials of Comparative Examples had a scratch-inducing force of 2.0 N or less, it could be seen that the flooring material of Example was not affected even by application of higher force in the scratch test. In addition, FIG. 7 is pictures showing dents and scratches of the flooring materials due to scratch damage depending upon test items as observed with respect to the flooring materials of Example and Comparative Example 1, and results of the tests for plastic ruler-induced dents, coin-induced dents, coin-induced scratches, and metal key-induced scratches are arranged in order. From the results, it could be seen that the flooring material of Example did not suffer from any dents and scratches regardless of kinds of tools used in the tests, and that the flooring material of Comparative Example 1 suffered from dents in the test for plastic ruler-induced dents, from whitening and breakage in the test for coin-induced dents, and from whitening and dents in the tests for coin-induced scratches and metal key-induced scratches.

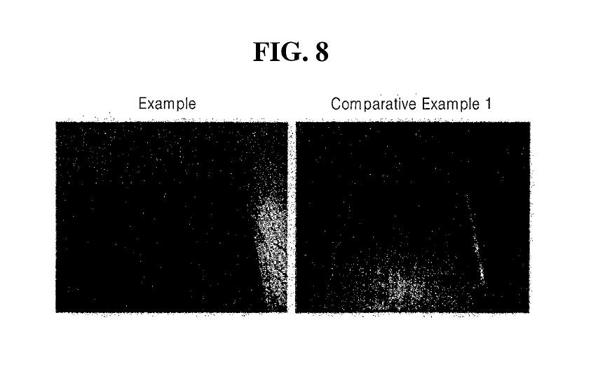

FIG. 8 is pictures showing results of a dent test using a caster resistance tester as observed with respect to the flooring materials of Example and Comparative Example 1. Here, the test was performed by applying impact using the casters of the chair. The flooring material of Comparative Example 1 suffered from dents and whitening even by impact applied 1,000 times or less, whereas the flooring material of Example did not show any changes even by impact applied 2,000 times or more. Thus, it can be anticipated that the flooring material of Example can be maintained without suffering from dents and damage upon use and maintenance thereof.

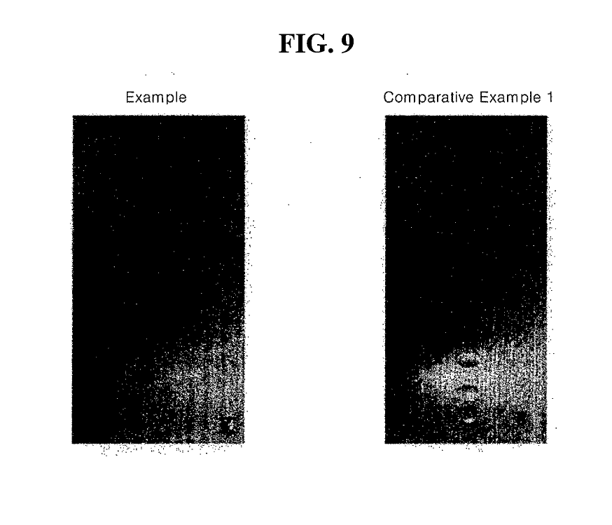

FIG. 9 is pictures showing results of a dent test using an impact resistance tester as observed with respect to the flooring materials of Example and Comparative Example 1. It could be confirmed by touch that the flooring material of Example started to suffer from dents when tested at a height of 500 cm or more, whereas it could be confirmed with the naked eye that the flooring material of Comparative Example 1 started to suffer from dents when tested at a height of 100 cm or more.

From the experimental results of <Experimental Example 3> and FIGS. 6 to 9, since the marble chip flooring material including the marble chip surface layer had a density of about three times that of existing PLA resin flooring materials, the marble chip flooring material exhibited excellent physical properties in terms of abrasion resistance, impact resistance, and the like. Thus, it could be seen that the marble chip flooring material provided outstanding effects in terms of surface damage due to a dent and impact in actual environments.

1. A marble chip flooring material comprising:
a marble chip surface layer comprising a polylactic acid (PLA) resin;
an adhesive layer and a plywood layer formed on a lower side of the marble chip surface layer; and
a surface treatment layer formed on an upper side of the marble chip surface layer.

2. The flooring material according to claim 1, wherein the marble chip surface layer comprises at least one of 5 parts by weight to 60 parts by weight of a non-phthalate plasticizer, 5 parts by weight to 60 parts by weight of an epoxy, 0.01 parts by weight to 10 parts by weight of stearic acid as a lubricant, 5 parts by weight to 30 parts by weight of a higher fatty acid, 10 parts by weight or less of an anti-hydrolysis agent, 500 parts by weight to 700 parts by weight of calcium carbonate, 5 parts by weight or less of titanium dioxide, 20 parts by weight or less of pine resin, and 5 parts by weight to 10 parts by weight of a pigment, based on 100 parts by weight of the PLA resin.

3. The flooring material according to claim 1, wherein the marble chip surface layer has a thickness from 0.2 mm to 5.0 mm.

4. The flooring material according to claim 1, wherein the marble chip surface layer has an amorphous marble pattern having a wavy and rough surface appearance.

5. The flooring material according to claim 1, wherein the adhesive layer comprises at least one selected from among epoxy, urethane, vinyl acetate, and acrylic resins.

6. The flooring material according to claim 1, wherein the adhesive layer has a thickness from 0.01 mm to 0.5 mm.

7. The flooring material according to claim 1, wherein the plywood layer is selected from among medium density fiberboard (MDF), plywood, cellulose fiber reinforced cement boards, magnesium boards, reclaimed wood, high density fiberboard (HDF), particle board (PB), ceramic tiles, porcelain tiles, ceramic boards, and click fasteners.

8. A method for preparing a marble chip flooring material, comprising:
preparing a marble chip surface layer comprising a PLA resin;
forming an adhesive layer and a plywood layer on a lower side of the marble chip surface layer; and
forming a surface treatment layer on an upper side of the marble chip surface layer.

9. The method according to claim 8, wherein preparing the marble chip surface layer comprises:
kneading a composition comprising at least one of 5 parts by weight to 60 parts by weight of a non-phthalate plasticizer, 5 parts by weight to 60 parts by weight of an epoxy, 0.01 parts by weight to 10 parts by weight of stearic acid as a lubricant, 5 parts by weight to 30 parts by weight of a higher fatty acid, 10 parts by weight or less of an anti-hydrolysis agent, 500 parts by weight to 700 parts by weight of calcium carbonate, 5 parts by weight or less of titanium dioxide, 20 parts by weight or less of pine resin, and 5 parts by weight to 10 parts by weight of a pigment, based on 100 parts by weight of the PLA resin; and
forming a marble chip surface layer by mixing the kneaded composition.

10. The method according to claim 9, comprising:
forming an amorphous marble pattern having a wavy and rough-surface appearance by rolling in a calendar on the formed marble chip surface layer.
